(19) United States
(12) Patent Application Publication
(10) Pub. No.: US 2015/0022280 A1
(43) Pub. Date: Jan. 22, 2015

(54) MICROSTRIP LINE/SLOT LINE TRANSITION CIRCUIT

(71) Applicant: THOMSON LICENSING, Issy de Moulineaux (FR)

(72) Inventors: Dominique Lo Hine Tong, Rennes (FR); Philippe Minard, Saint Medard Sur Ille (FR); Ali Louzir, Rennes (FR)

(21) Appl. No.: 14/362,516

(22) PCT Filed: Dec. 6, 2012
(86) PCT No.: PCT/EP2012/074659

§ 371 Date: Sep. 30, 2014

(30) Foreign Application Priority Data
Dec. 12, 2011 (FR) 1161437

(51) Int. Cl. H01P 5/10

(52) U.S. Cl. CPC H01P 1/2039; H01P 1/268
USPC 333/26; 333/33

(57) ABSTRACT

The invention relates to a circuit for transition from a microstrip line to a slot line. According to the invention, the slot line of the transition circuit is equipped with a filter for providing on the slot line, at the crossover zone of the microstrip line and the slot line, an impedance substantially equal to the impedance of an open circuit for at least one desired frequency of the signal and an impedance substantially equal to the impedance of a short circuit for at least one undesirable frequency of the signal. Advantageously, the microstrip line is also equipped with a filter for providing on the microstrip line, at the crossover zone, an impedance substantially equal to the impedance of a short circuit for the desired frequency and an impedance substantially equal to the open-circuit impedance for the undesirable frequency.

The present invention relates to a circuit for transition from a microstrip line to a slot line. The invention finds an application in the field of radio communications and notably in the field of multi-standard multi-mode user terminals working in close frequency bands.

Multi-standard multi-mode user terminals incorporate multiple wireless communication or radio-communication systems and are subject to high interference due to, on the one hand, the proximity of the frequency bands allocated to the different systems and, on the other hand, the physical proximity of the antennas, the size of the terminals being increasingly reduced. The result is harmful interference interactions between the different systems.

To reduce these interference interactions, a first known solution consists in introducing, within the terminal, a frequency-selective filter into the transmission-reception chain of each of the systems, this filter being intended to reject the undesirable frequencies for the system considered, such as the interference signals from other systems, and/or the interference from the transmission/reception chain in question and/or harmonics. However, the performance requirements for these filters being very stringent (very low insertion losses, high selectivity and very narrow passband), they cannot currently be implemented in a low-cost technology, for example with FR4 substrate-based printed circuits.

In the case of terminals equipped with slot antennas, such as the antennas known as “tapered slot antennas” or Vivaldi antenna, another known solution consists in filtering the interference signals in the microstrip line/slot line transition circuits used to make the transition between the microstrip lines of the transmission-reception chains and the slot antennas of terminal. Such a solution is described in patent application WO 2006/018567. In this document, the filtering of interference signals is achieved by adjustment of the length of the microstrip line and/or the length of the slot line of the transition circuit. However, this solution is unsatisfactory as it filters undesirable frequencies to the detriment of the response in transmission of the transition circuit in the useful band (the electromagnetic coupling between the microstrip line and the slot line is no longer maximal).

One purpose of the invention is to propose a microstrip line/slot line transition circuit able to filter undesirable frequencies without degrading the performances of the transition circuit in the useful band.

Another purpose of the invention is to propose such a transition circuit which is implementable in a low-cost technology.

Also, the purpose of the invention is a circuit for transition from a microstrip line to a slot line comprising a substrate equipped with a ground plane, a microstrip line implemented on said substrate at a predetermined distance from the ground plane and extending from a first input/output port, and a slot implemented in the ground plane forming a slot line extending substantially perpendicularly to said microstrip line as far as a second input/output port and crossing said microstrip line in a so-called coupling zone of the transition circuit, said microstrip line comprising a first microstrip line portion for transmitting a signal between the first input/output port and the coupling zone, and a second microstrip line portion, said slot line comprising a first slot line portion for transmitting said signal between the coupling zone and the second input/output port, and a second slot line portion. According to the invention, the slot line comprises a first filtering circuit connected to the coupling zone via said second slot line portion, said first filtering circuit and said second slot line portion being impedance-matched to provide on the slot line, at the coupling zone, an impedance substantially equal to the impedance of an open circuit for at least one desired frequency of the signal and an impedance substantially equal to the impedance of a short circuit for at least one undesirable frequency of the signal.

Thus, according to the invention, a filtering circuit connected to the second slot line portion is used to provide, by reflection, optimal electromagnetic coupling conditions on the slot line at the coupling zone of the transition circuit for the desired frequency and near-zero electromagnetic coupling conditions for the undesirable frequency.

According to a preferred embodiment, a filtering circuit is also connected to the second microstrip line portion to provide, by reflection, optimal electromagnetic coupling conditions on the microstrip line at the coupling zone of the transition circuit for the desired frequency and near-zero electromagnetic coupling conditions for the undesirable frequency. In this embodiment, the microstrip line comprises a second filtering circuit connected to the coupling zone via said second microstrip line portion, said second filtering circuit and said second microstrip line portion being impedance-matched to provide on the microstrip line, at the coupling zone, an impedance substantially equal to the impedance of a short circuit for said at least one desired frequency and an impedance substantially equal to the open-circuit impedance for said at least one undesirable frequency.

According to a particular embodiment, the first filtering circuit disposed on the slot line is a filter connected to a load resistor and able to reject said at least one desired frequency and to pass said at least one undesirable frequency and the second slot line portion corresponds substantially to a quarter-wave slot line for said at least one desired frequency.

Likewise, the second filtering circuit disposed on the microstrip line is a filter connected to a load resistor and able to reject said at least one desired frequency and to pass said at least one undesirable frequency and the second microstrip line portion corresponds substantially to a quarter-wave microstrip line for said at least one desired frequency.

According to a particular embodiment, the first and second filtering circuits are band-stop filters rejecting said at least one desired frequency and passing said at least one undesirable frequency.

According to another particular embodiment, the first and second filtering circuits are band-pass filters passing said at least one undesirable frequency and rejecting said at least one desired frequency.

According to a particular embodiment, the transition circuit is implemented in a low-cost technology, by implementing for example the circuit on a substrate of FR4 type.

The invention also relates to a multi-standard terminal comprising at least one transition circuit as described above.

The invention will be better understood, and other aims, details, characteristics and advantages will appear more clearly over the course of the detailed description which follows in referring to the figures in the appendix, showing in:

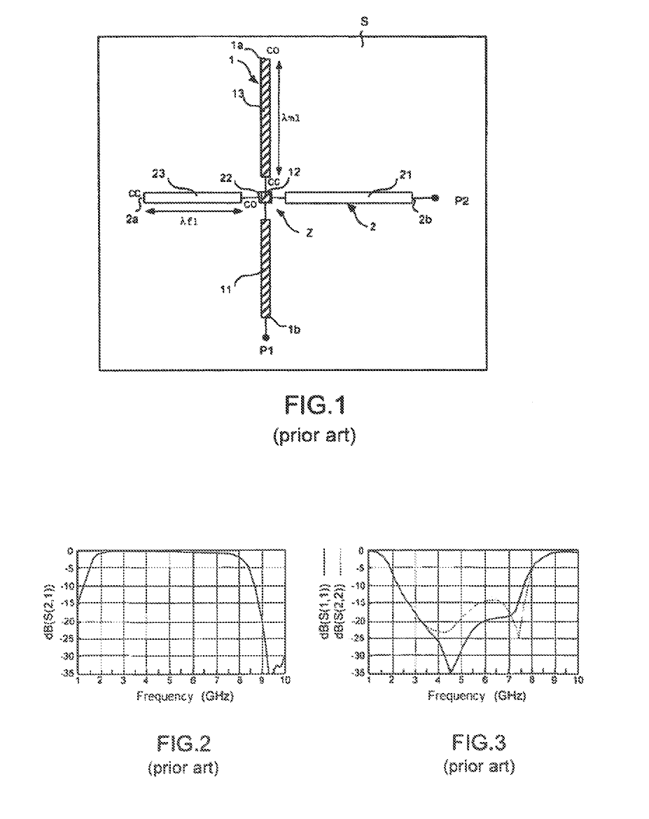

FIG. 1, a diagrammatic view of a standard microstrip line/slot line transition circuit, of Knorr type;

FIG. 2, a graph showing the simulated response in transmission S(2,1) of the circuit of FIG. 1;

FIG. 3, a graph showing the simulated responses in reflection, S(1,1) and S(2,2), of the circuit of FIG. 1;

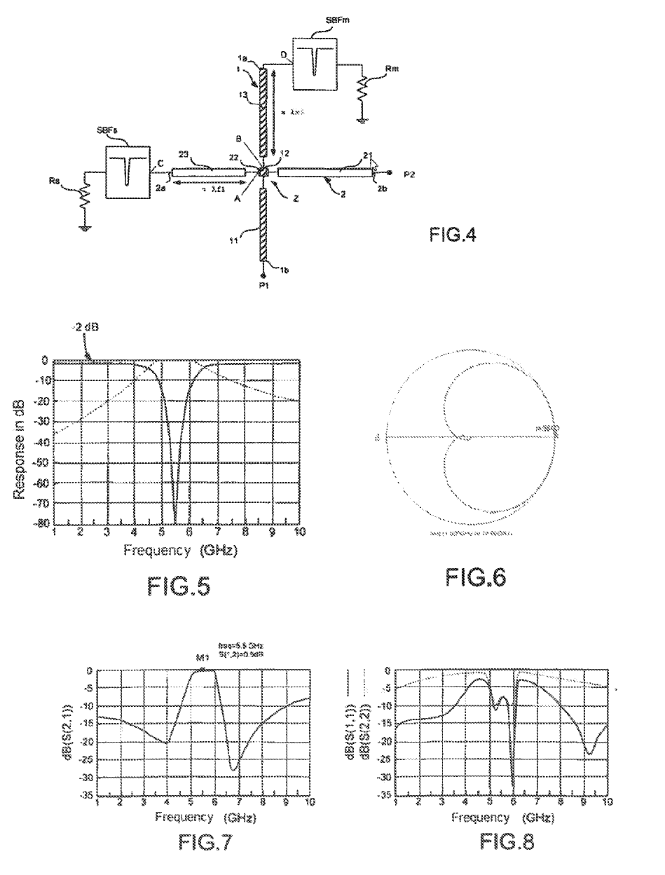

FIG. 4, a diagrammatic view of the microstrip line/slot line transition circuit in accordance with the invention and using band-stop filters;

FIG. 5, graphs showing the simulated responses in transmission and in reflection of a Chebyshev band-stop filter used in the circuit of FIG. 4;

FIG. 6, a graph showing the response in reflection at the input of the Chebyshev filter;

FIGS. 7 and 8, graphs showing the simulated responses in transmission and in reflection of the circuit of FIG. 4,

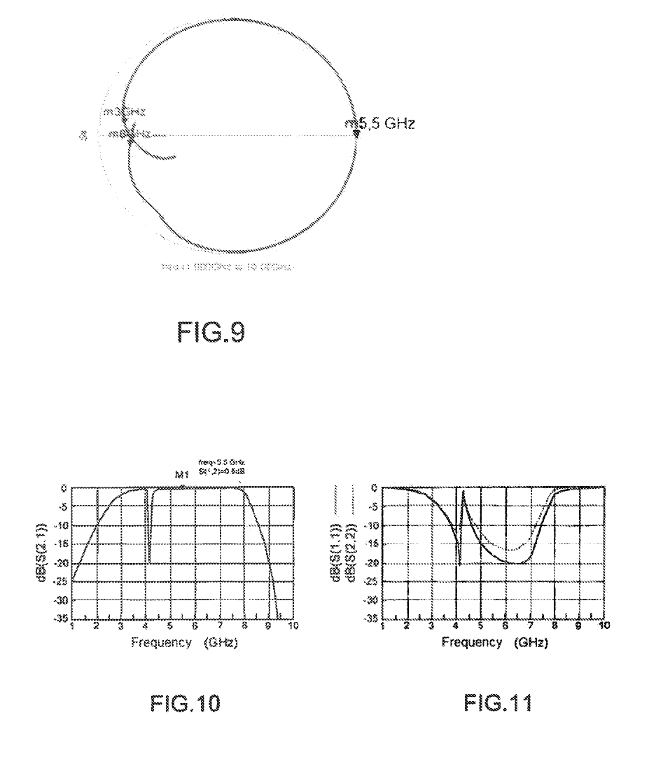

FIG. 9, a graph showing the response in reflection at point A of the circuit of FIG. 4; and

FIGS. 10 and 11, graphs showing the simulated response in transmission and in reflection of a circuit as shown in FIG. 4 but wherein the band-stop filters were replaced with band-pass filters.

FIGS. 1 to 3 show a standard microstrip line/slot line transition circuit of Knorr type. With reference to FIG. 1, the transition circuit is implemented on a substrate S equipped with a ground plane. It comprises a microstrip line 1 and a slot line 2 etched in the ground plane, the microstrip line being disposed at a predetermined distance from the ground plane. Microstrip line 1 terminates, at a first end 1a, in an open circuit CO and, at a second end 1b, in an input port P1. Slot line 2 terminates, at a first end 2a, in a short circuit CC and, at a second end 2b, in an output port P2. Port P1 is connected to a transmission chain and port P2 is connected to a slot antenna.

Microstrip line 1 extends substantially perpendicularly to slot line 2 and the two lines cross in a so-called coupling zone, Z, of the transition circuit.

More specifically, microstrip line 1 comprises a microstrip line portion 11 connected to port P1 being extended by a microstrip line portion 12, called a coupling portion, disposed above slot line 2, said coupling portion 12 itself being extended by a portion 13 terminating in an open circuit. Likewise, slot line 2 comprises a slot line portion 21 connected to port P2 being extended by a slot line portion 22, called a coupling portion, disposed below microstrip line 1, said coupling portion 22 itself being extended by a portion 23 terminating in an short circuit CC. Portions 12 and 22 define the above-mentioned coupling zone Z. The transfer of energy from port P1 to port P2 is done by electromagnetic coupling of portions 12 and 22.

It should be noted that the microstrip line has been shown using hatches to distinguish it more clearly from the slot line. Likewise, to distinguish more clearly the different portions of each of the lines, they have been separated and connected by lines which in reality do not exist.

To obtain optimal electromagnetic coupling conditions between microstrip line 1 and slot line 2, portions 13 and 23 must respectively provide a short circuit and an open circuit at the transition zone Z. For this purpose, the length of portion 13 must be substantially equal to λm1/4 where λm1 is the guided wavelength in the microstrip line associated with a desired frequency f1 (working frequency of the transition circuit). Likewise, the length of portion 23 must be substantially equal to λf1/4 where λf1 is the guided wavelength in the slot line associated with the desired frequency f1.

Finally, the function of portions 11 and 21 is to provide, respectively at ports P1 and P2, an impedance close to that present at ports P1 and P2, generally 50 ohms for P1 and in the order of 80-100 ohms for port 2.

As can be seen in FIGS. 3 and 4, this circuit for transition from a microstrip line to a slot line is applicable to functioning in the 5 GHz WiFi band. It has been implemented on a very low-cost FR 4 material-based multilayer substrate.

In view of the graphs of FIGS. 3 and 4, it is noted that the transition circuit of FIG. 1 has the following characteristics:
very wide passband, in the order of 6 GHz;
low insertion losses in the passband between ports P1 and P2, in the order of 0.5 dB;
low reflection coefficients at ports P1 and P2 in the passband.

It is therefore noted that this transition circuit is intrinsically very wide band and easily covers the needs of wireless communication systems which, for their part, are by contrast very narrow band in nature, with the exception of systems of UWB type.

According to the invention, it is sought to reduce the passband of the transition circuit so that it approaches the useful band for wireless communication systems, while maintaining very low insertion losses. According to the invention, a frequency-selective microstrip line/slot line transition, able to pass desired frequencies contained in a useful band and to reject frequencies outside this useful band, is therefore proposed.

A block diagram of the transition circuit according to the invention is shown in FIG. 4. With respect to the diagram of FIG. 1, the transition circuit comprises the following modifications:
microstrip line portion 13 is connected at its end la to a band-stop filter SBFm connected to the ground via a load resistor Rm, said filter being designed to reject the frequencies of the useful band;
slot line portion 13 is connected at its end 2a to a filter SBFs connected to the ground via a load resistor Rs, this filter also being designed to reject the frequencies of the useful band.

The role of the filters is to provide the required selectivity by providing by reflection at the coupling zone Z the optimal coupling conditions, that is to say therefore a short circuit (respectively an open circuit) for the microstrip line (respectively slot line) in the useful band of the transition. Thus, the important thing in the proposed circuit is the reflected response at the input of the filters, namely a response of band-pass type.

The role of line portions 13 and 23 is to provide the impedances of inputs C and D of the filters at the impedances required at the coupling zone to favour the maximum power transfer in the useful band from Port P1 to Port P2 according to the KNORR principle, namely a zero impedance (short circuit) in B and an infinite impedance (open circuit) in A.

Conversely, outside the useful band, what is sought is the maximum attenuation of the signal transmitted from port P1 to port P2. To do so, it is important that the impedance provided at the input of the coupling zone, at point A, by slot line portion 23, the band-stop filter SBFs and its load Rs, is low, close to the impedance of a short circuit. As a result, outside the useful band, the signal transmitted at port P1 is almost completely transmitted to load Rm via microstrip line portion 12 and filter SBFm, and very little to port P2. For this purpose too, it is important that the impedance of port P2 is higher than that of port P1 (typically 50 ohms), which is generally the case if it is considered that port P2 is the excitation port of a slot antenna.

Multiple parameters are available to attain the optimal conditions of selectivity sought, the impedance levels sought at the coupling zone outside and within the useful band of the transition, namely: the characteristic impedances and the lengths of line portions 13 and 23, the load resistances Rm and Rs and the impedances of the elements intrinsic to each of the filters SBFm and SBFs.

Line portion 11 serves, if necessary, to provide the impedance at port P1 at the usual value of 50 ohms.

The transition circuit of FIG. 4 was simulated using Agilent/ADS software for a filtering transition passing the 5 to 6 GHz band. First, the coupling of portion 12 of the microstrip line with portion 22 of the slot line was modelled with the Agilent/Momentum electromagnetic simulator to extract the S-parameters therefrom. Then, a simulation of the circuit was carried out by taking for the other components of the circuit, namely the other line portions and the loaded filters, their equivalent electrical model, therefore disregarding their technique and technology of implementation.

The line portions are defined by their electrical length at a given frequency and their characteristic impedance. As regards the band-stop filter, a filter having a response of Chebyshev type with the following characteristics was selected:
central frequency: 5.5 GHz;
ripple level outside rejected band: 0.1 dB;
rejection band (BWpass) of 2.5 GHz for a given attenuation (Apass) of 1 dB;
the impedance provided at the inputs of the filter in the rejection band (StopType) is an open circuit for filter SBFm and a short circuit for filter SBFs;
order of the filter equal to 2;
insertion losses: 2 dB;
reference impedance at the inputs (Z1) and output of the filter (Z2):
   Z1=Z2=50Ω for filter SBFm;
   Z1=Z2=80Ω for filter SBFs.

The responses of a filter SBFm thus defined are shown by FIGS. 5 and 6. FIG. 5 shows the insertion losses, the passband and the rejection level and FIG. 6 shows that this filter SBFm indeed presents an open circuit at its inputs at the central frequency of 5.5 GHz.

It is noted especially here that the response in reflection of the band-stop filter is that of a band-pass filter, passing the 5 to 6 GHz band. This inverse (reflected) response and its advantages are exploited by the invention.

The 2 filters of the circuit are of order 2 and have theoretical insertion losses of 2 dB. The parameters of the embedded components of the circuit of FIG. 4 are given in the table below. They have been optimised to fulfil the conditions required to attain the desired performances.

| | | |
|---|---|---|
| | | Electrical |
| | Impedance | length |
| Component | (ohms) | (degrees) |

microstrip line and port P1

| | | |
|---|---|---|
| Port P1 | 50 | |
| Portion 11 | 60 | 90 |
| Portion 13 | 70 | 80 |
| Load resistor Rm | 50 | |

Slot line and port P2

| | | |
|---|---|---|
| Port P2 | 80 | |
| Line Ls2 | 25 | 80 |
| Filter SBFs | 25 | |
| Load resistor Rs | 80 | |

The following performances are obtained for the transition circuit. FIG. 7 shows the response in transmission of the transition and FIG. 8 shows the responses in reflection. The response in transmission is of band-pass type with a passband ranging from 5 to 6 GHz. In the immediate neighbourhood of this band, the signal is rejected by more than 20 dB. Moreover, the transition is well impedance-matched in the passband, with reflection levels less than −12 dB.

The low insertion losses of the transition, around 0.5 dB, should be noted. It is therefore clearly demonstrated here that the insertion losses of the band-stop filters (2 dB) have no impact on the insertion losses of the transition. This is a huge advantage since this means that the filters and the transition circuit itself can be implemented with a low-cost technology, for example on a substrate of FR 4 type.

Outside the passband of the transition, the excitation port P1 is also well impedance-matched (dB(S11)). This shows that the signal is not reflected and is transmitted to a load, namely here the load Rm of band-stop filter SBFm. This is only made possible because, outside the passband of the transition, the slot band-stop filter SBFs does provide a very low impedance at the coupling zone, at point A. This is demonstrated in FIG. 9. In this figure, it can be seen that the band-stop filter provides at point A a low impedance close to a short circuit at 3 GHz and at 8 GHz (outside the passband) and an open circuit at 5.5 GHz (in the passband).

As noted above, the response in transmission of the transition circuit described above is of band-pass type, the interfering frequencies to be removed being present outside the passband of the circuit.

According to another embodiment, the band-stop filters can be replaced with band-pass filters so as to obtain a response of the transition circuit of band-stop type. Such a response makes it possible, for example, to reject an interfering signal in a clearly-identified frequency band.

This embodiment has been simulated. The two band-pass filters used for this simulation are of order 2, centred around 4.2 GHz and have a very narrow bandwidth equal to 100 MHz. The simulated responses of the transition are shown in FIGS. 10 and 11. In the response in transmission, the response of band-pass type of a standard transition is found here. But note especially that the band is cut around 4.2 GHz due to the presence of the two band-pass filters of the transition circuit.

The transition circuit according to the invention has the following advantages:
the transition can be ultra frequency-selective and the insertion losses do not depend on those of the filters introduces into the circuit, but essentially on those of the coupling zone; this means that the filters can be implemented using very low-cost technologies, and the quality factors of the resonant elements of the filters can be low; and
the transition does not require the inserted filters to be of high order to obtain a very frequency-selective response, thereby presenting an advantage in terms of size.

Moreover, several variants are possible:
Filter SBFm mounted on the microstrip line can be eliminated to the detriment of the frequency-selectivity performances of the transition circuit;
Apart from an application to the excitation of slot antennas, the circuit can also be used as a standard filtering circuit inserted into a transmission/reception chain, in which case, it is sufficient to connect to port P2 a standard slot line/microstrip line transition circuit (inverse transition circuit); and
The response of the transition circuit can be frequency tunable if the filters are.

1. Circuit for transition from a microstrip line to a slot line comprising:
a substrate equipped with a ground plane,
a microstrip line implemented on said substrate at a predetermined distance from the ground plane and extending from a first input/output port, and a slot implemented in the ground plane forming a slot line extending substantially perpendicularly to said microstrip line as far as a second input/output port and crossing said microstrip line in a so-called coupling zone of the transition circuit,
said microstrip line comprising a first microstrip line portion for transmitting a signal between the first input/output port and the coupling zone, and a second microstrip line portion,
said slot line comprising a first slot line portion for transmitting said signal between the coupling zone and the second input/output port, and a second slot line portion,
wherein the slot line comprises a first filtering circuit connected to the coupling zone via said second slot line portion, said first filtering circuit and said second slot line portion being impedance-matched to provide on the slot line, at the coupling zone, an impedance substantially equal to the impedance of an open circuit for at least one desired frequency of the signal and an impedance substantially equal to the impedance of a short circuit for at least one undesirable frequency of the signal.

2. Transition circuit according to claim 1, wherein the microstrip line comprises a second filtering circuit connected to the coupling zone via said second microstrip line portion, said second filtering circuit and said second microstrip line portion being impedance-matched to provide on the microstrip line, at the coupling zone, an impedance substantially equal to the impedance of a short circuit for said at least one desired frequency and an impedance substantially equal to the open-circuit impedance for said at least one undesirable frequency.

3. Transition circuit according to claim 1, wherein the first filtering circuit is a filter connected to a load resistor and able to reject said at least one desired frequency and to pass said at least one undesirable frequency and in that the second slot line portion corresponds substantially to a quarter-wave slot line for said at least one desired frequency.

4. Transition circuit according to claim 3, itself dependent on claim 2, wherein the second filtering circuit is a filter connected to a load resistor and able to reject said at least one desired frequency and to pass said at least one undesirable frequency and in that the second microstrip line portion corresponds substantially to a quarter-wave microstrip line for said at least one desired frequency.

5. Transition circuit according to claim 4, wherein the first and second filtering circuit are band-stop filters.

6. Transition circuit according to claim 4, wherein the first and second filtering circuit are band-pass filters.

7. Transition circuit according to claim 1, wherein the substrate is of FR4 type.

8. Multi-standard terminal wherein it comprises at least one transition circuit according to claim 1.
